(19) United States
(12) Patent Application Publication
(10) Pub. No.: US 2026/0097702 A1
(43) Pub. Date: Apr. 9, 2026

(54) INTEGRATED HYDRAULIC STORAGE AND HEAT EXCHANGE

(71) Applicant: Caterpillar Inc., Peoria, IL (US)

(72) Inventors: Mihai-Dragos STRAT, Staffordshire (GB); Mark Andrew SMITH, County Durham (GB); Tristan Oliver DEVEREUX, Lincolnshire (GB); Matthew DIXON, Tyne & Wear (GB)

(73) Assignee: Caterpillar Inc., Peoria, IL (US)

(21) Appl. No.: 18/905,449

(22) Filed: Oct. 3, 2024

(51) Int. Cl. B60P 1/16

(52) U.S. Cl. CPC B60P 1/162

(57) ABSTRACT

A work machine includes a hydraulic pump in fluid communication with an interior of a support structure. The hydraulic pump is constructed to impel hydraulic fluid stored therein. Work machinery is mechanically coupled to the support structure and operated by the impelled hydraulic fluid.

### TECHNICAL FIELD

The present disclosure relates to hydraulic systems and more specifically hydraulic systems on work machines and the thermal management thereof.

### BACKGROUND

A hydraulic system, like those employed on large work machines, can be thought of as comprising a hydraulic pump, a hydraulic fluid reservoir, such as a fluid tank, a system of conduits, valves, etc., constructed to deliver to, and to implement control over the flow of the hydraulic fluid in hydraulically operated work machinery. The work machinery may include heat sinks and the like to dissipate heat imparted to the hydraulic fluid.

One such system is disclosed in World Intellectual Property Organization (WIPO) document WO2009031947A1, entitled “Heat Exchanger and Traction Vehicle provided with such a Heat Exchanger.” The disclosed system includes a heat exchanger having a channel system for circulating a first fluid therein, and adapted to promote heat transfer between the first fluid and at least one of a second fluid circulated in the channel system and ambient air. The heat exchanger has an upper support surface and has a structural strength sufficient to support a person standing thereon, and comprises a fitting for mounting the heat exchanger on a traction vehicle enabling a person to stand on the support surface. Such a heat exchanger may be used on several places on a vehicle where a supporting structure is required, for example steps and standing platforms. By using such a structure as a heat exchanger, its surface, used for standing on, will be heated.

While several thermal management techniques exist, engineering and product development resources continue to be expended towards efficient thermal management and heat storage.

### SUMMARY

In one aspect of the present inventive concept, a work machine includes a chassis and a support structure having a hollow interior and mechanically coupled to the chassis. A bladder is located within the hollow interior of the support structure and is constructed to contain hydraulic fluid therein. A hydraulic pump is in fluid communication with the interior of the bladder and is constructed to impel the hydraulic fluid stored therein. Hydraulic work machinery is mechanically coupled to the chassis and operated by the impelled hydraulic fluid.

In another aspect of the present inventive concept, a hauling machine includes a support structure having hollow structural components. A pump is in fluid communication with the hollow structural components and is constructed to impel hydraulic fluid stored therein. A bed is mechanically coupled to the support structure and operated into loading and dumping states by the impelled hydraulic fluid.

In yet another aspect of the present inventive concept, a work machine includes a hydraulic pump in fluid communication with an interior of a support structure. The hydraulic pump is constructed to impel hydraulic fluid stored therein. Work machinery is mechanically coupled to the support structure and operated by the impelled hydraulic fluid.

### BRIEF DESCRIPTION OF THE DRAWINGS

FIG. 1 is a schematic block diagram of an exemplary hydraulic apparatus of a work machine by which the present inventive concept can be embodied.

FIG. 2 is an illustration of an exemplary heat storage/heat exchange apparatus of a work machine by which the present inventive concept can be embodied.

FIG. 3 is an illustration of different configurations of hydraulic channels by which the present inventive concept can be embodied.

FIG. 4 is an illustration of an exemplary chassis for a work machine by which the present inventive concept can be embodied.

FIG. 5 is an illustration of an exemplary support structure by which the present inventive concept can be embodied.

### DESCRIPTION OF EXAMPLE EMBODIMENTS

The present inventive concept is best described through certain embodiments thereof, which are described in detail herein with reference to the accompanying drawings, wherein like reference numerals refer to like features throughout. It is to be understood that the term invention, when used herein, is intended to connote the inventive concept underlying the embodiments described below and not merely the embodiments themselves. It is to be understood further that the general inventive concept is not limited to the illustrative embodiments described below and the following descriptions should be read in such light.

Additionally, the word exemplary is used herein to mean, “serving as an example, instance or illustration.” Any embodiment of construction, process, design, technique, etc., designated herein as exemplary is not necessarily to be construed as preferred or advantageous over other such embodiments.

The figures described herein include schematic block diagrams illustrating various interoperating functional modules. Such diagrams are not intended to serve as electrical/hydraulic schematics and interconnections illustrated are intended to depict signal/fluid flow, various interoperations between functional components and/or processes and are not necessarily direct electrical/hydraulic connections between such components. Moreover, the functionality illustrated and described via separate components need not be distributed as shown, and the discrete blocks in the diagrams are not necessarily intended to depict discrete electrical/hydraulic components.

The techniques described herein are directed to heat storage/heat exchange in work machines. Upon review of this disclosure and appreciation of the concepts disclosed herein, the ordinarily skilled artisan will recognize other thermal management/fluid storage contexts in which the present inventive concept can be applied. The scope of the present invention is intended to encompass all such alternative implementations.

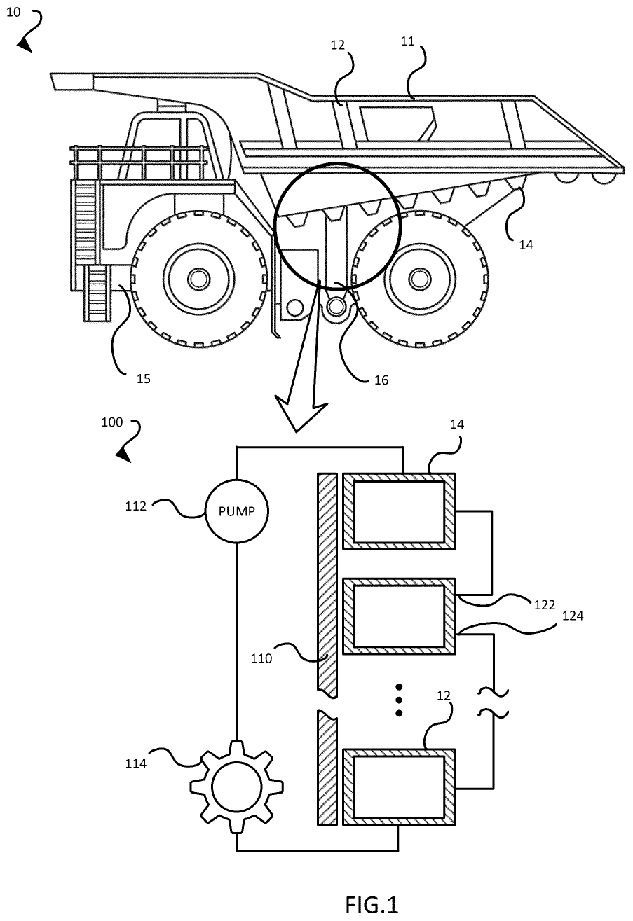

FIG. 1 is a schematic block diagram of an exemplary hydraulic apparatus 100 of a work machine 10 by which the present inventive concept can be embodied. In this example, work machine 10 is a hauling machine, but it is to be understood that the present inventive concept may be embodied in other work machines as well. Work machine 10 may have a chassis 15 that is constructed to transfer the weight of the work machine subsystems to the wheels (or tracks), representatively illustrated at wheel 18. Work machine 10 may have multiple hydraulically operated subsystems on chassis 15, representatively illustrated by hydraulic cylinder 16, by which work tasks (in this case, loading and dumping materials) may be achieved.

Work machine 10 may have a hydraulic pump 112 that impels hydraulic fluid from a fluid reservoir, which may be constructed as hydraulic fluid stored in hollow components of work machine 10, to work machinery 114. The hollow components may be interconnected to create a distributed fluid reservoir. To that end, each hollow component may have a fluid outlet port 112, through which hydraulic fluid is drawn from the hollow components, and a fluid inlet port 114 through which hydraulic fluid is accepted into the hollow components. Inlet ports 114 and outlet ports 112 may be connected one with another through fluid interconnectors, representatively illustrated at fluid interconnector 126. Fluid interconnectors 126 may be fabricated from hydraulic fluid tolerant materials, including rubber, metal, various plastics, etc. Alternatively, fluid interconnectors 126 may be structures within a header (or headers).

Work machine 10 may have a bed 11 in which material is contained for hauling. To empty bed 11, hydraulic cylinder 16 may be extended under hydraulic force of pressurized hydraulic fluid stored in the hollow components. Once bed 11 is empty, hydraulic cylinder 16 may be retracted to place work machine 10 in a ready state for reloading.

On bed 11, and elsewhere on work machine 10, stiffening components may be attached. Such stiffening components may be generally referred to as support structures, which may be constructed from support components. Stiffeners 14 may add rigidity to the bottom of bed 11 and stiffeners 12 may add rigidity to the sides of bed 11. As illustrated in FIG. 1, stiffeners 12 and 14 may be hollow to contain hydraulic fluid and, in so doing, eliminates the need for a separate hydraulic fluid tank. In some cases, a structural component may have an open cross-sectional profile that is closed by attachment to a supported structure (e.g., bed 11) to therewith form a leak resistant hollow support structure.

Thermal management of work machine 10 may be achieved by heatsinks, representatively illustrated at heatsink 110. In one embodiment, heatsink 110 may be realized by bed 11, although other components may serve as a heatsink. Advantageously, the heat transferred to bed 11 may heat the material contained therein, which ameliorates material sticking to bed 11. Alternatively, heat sink 110 may be realized as a thermally conductive material in a dedicated heat sink, or heat sink 110 may be ambient air.

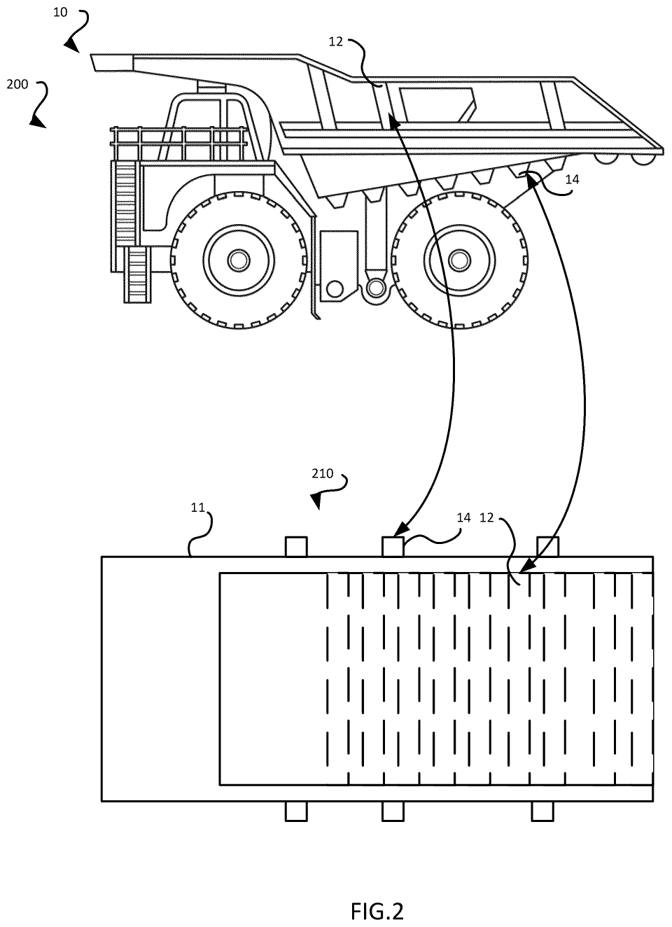

FIG. 2 is an illustration of an exemplary heat storage/heat exchange apparatus 200 of a work machine 10 by which the present inventive concept can be embodied. As illustrated in the figure, fluid reservoir 210 may be implemented as interconnected channels, representatively illustrated at channel 212, formed within the hollow stiffeners 12 and 14. That is, the fluid reservoir 210 may be distributed over bed 11 by stiffeners 12 and 14, although other components may be included in the distributed fluid reservoir 210. Again, through the distributed fluid reservoir 210, a hydraulic fluid tank may not be necessary.

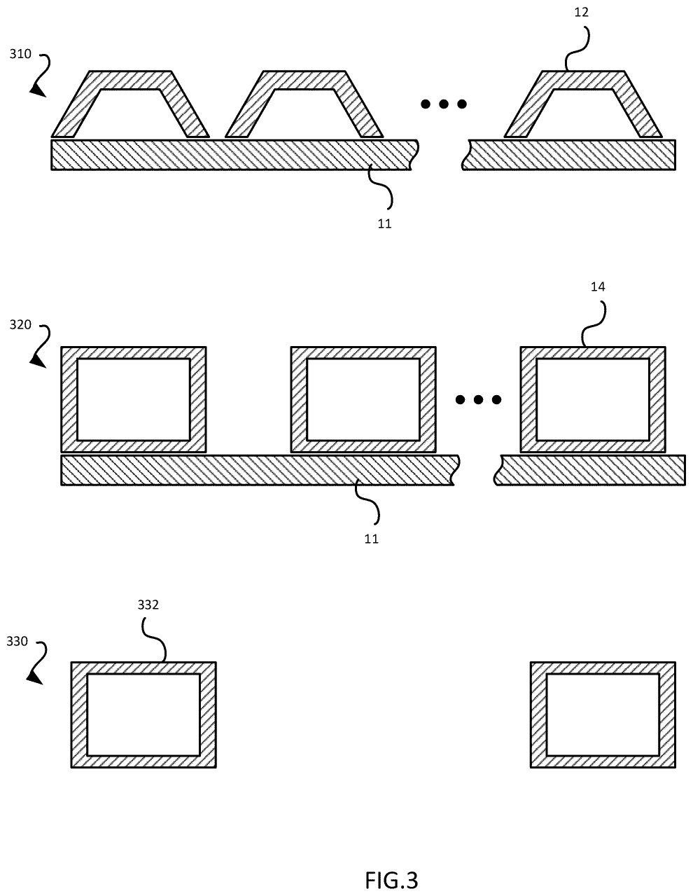

FIG. 3 is an illustration of different configurations of hydraulic channels 212 by which the present inventive concept can be embodied. It is to be understood that the configurations of FIG. 3 do not constitute an exhaustive list; many different configurations may be realized without departing from the spirit and intended scope of the present inventive concept.

In configuration 310, stiffeners 12 may be fabricated from a metal, such as steel or aluminum, into structural components having an open trapezoidal profile. Stiffeners 12 may be welded to bed 11 in a manner that prevents fluid leakage to create an array of hydraulic fluid channels 212, of a distributed fluid reservoir 210. In this configuration, bed 11 is part of the fluid channels and closing the open face of the trapezoidal profile completes the hollow support structure.

In configuration 320, stiffeners 14 may have a closed rectangular profile that can serve as a support structure and, by way of the present inventive concept, a hydraulic fluid reservoir within fluid channel 212. Again, stiffeners 14 may be welded to bed 11, which may serve as a heat sink.

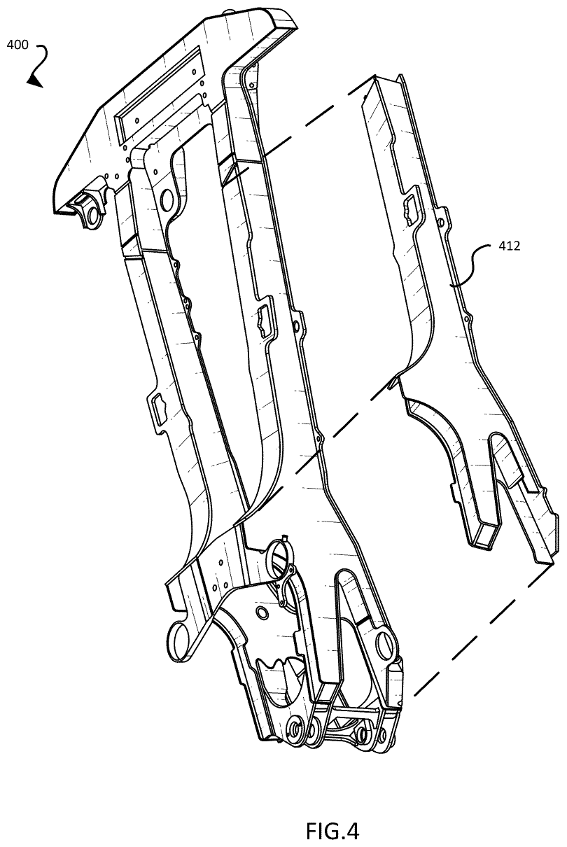

In configuration 330, support beams 332 may have a closed profile of a support structure, not necessarily the profile illustrated (see FIG. 4), to contain a volume of hydraulic fluid in channel 212. Here, the dissipation of heat is achieved via ambient air.

FIG. 4 is an illustration of an exemplary chassis 400 for a work machine 10 by which the present inventive concept can be embodied. As stated above, chassis 400 may constructed to transfer the weight of the work machine subsystems to the wheels (or tracks) thereof.

Chassis 400 may be of unitary body construction from hollow components that can each or collectively serve as a hydraulic fluid reservoir. In one implementation, beam 412 may be welded to chassis 400 and filled with hydraulic fluid. Heat may be dissipated into ambient air and other components attached to chassis 400.

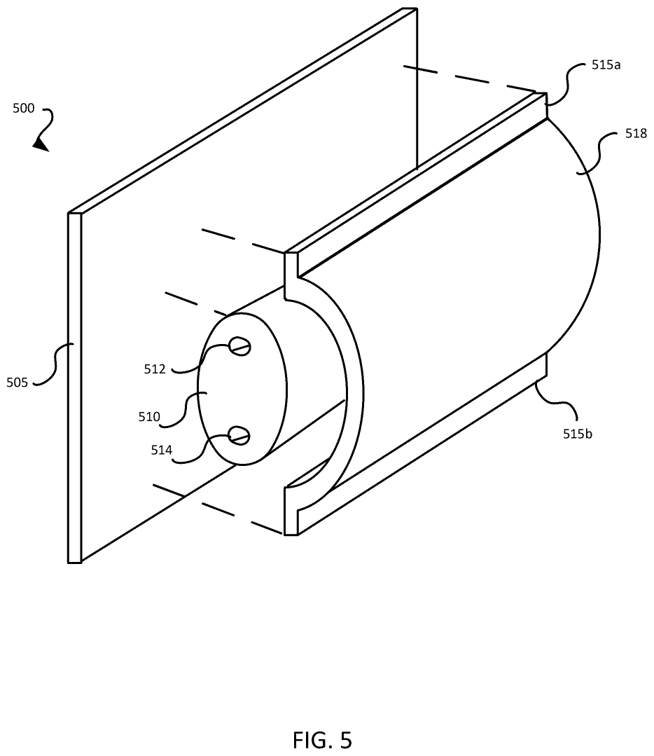

FIG. 5 is an illustration of an exemplary support structure 500 by which the present inventive concept can be embodied. Support structure 500 may be a mechanical stiffener, a support beam, or any structure supporting components on work machine 10. Such supporting structure may be realized by structural component 518, which may be mechanically coupled to a supported structure 505 (the structure being supported or otherwise reinforced by structural component 518). Structural component 518 may have flanges 515a and 515b formed thereon at which structural component 518 may be mechanically attached to supported structure 505, such as by welding, gluing, etc. It is to be understood that support component 518 and supported structure 505 may be joined without flanges 515a and 515b.

In the example of FIG. 5, support component 518 has a generally arcuate cross-sectional profile, although the present inventive concept is not so limited. Those skilled in the mechanical arts will recognize that support components can fabricated with different profiles without departing from the spirit and intended scope of the present inventive concept. With structural component 518 being attached to supported structure 505, the resulting support structure 500 may be a hollow assembly having an interior chamber or channel having a cross-sectional profile defined by those of structural component 518 and supported structure 505.

As illustrated in FIG. 5, the hollow interior of support structure 500 may be occupied by a bladder 510 constructed to contain a volume of hydraulic fluid therein. Bladder 510 may be fabricated from material, such as rubber, plastic, etc., formed into a membrane sufficiently thick to prevent leaks from support structure 500.

Bladder 510 may act as a hydraulic accumulator that absorbs or stores hydraulic energy. That is, pressurized hydraulic fluid may be stored in bladder 510 and returned to the hydraulic system depending on the flow impelled by pump 112. To do so, bladder 510 may have formed therein an inlet port 512 through which hydraulic fluid is accepted into the interior thereof. Bladder 510 may further include an outlet port 514 through which hydraulic fluid is drawn from the interior thereof.

Embodiments of the disclosed subject matter can also be as set forth according to the following parentheticals.
(1). A work machine comprising: a chassis; a support structure having a hollow interior and mechanically coupled to the chassis; a bladder within the hollow interior of the support structure and constructed to contain hydraulic fluid therein; a hydraulic pump in fluid communication with the interior of the bladder and constructed to impel the hydraulic fluid stored therein; and hydraulic work machinery mechanically coupled to the chassis and operated by the impelled hydraulic fluid.
(2.) The work machine of (1), wherein the support structure is distributed over the work machine as hollow channels constructed to contain respective bladders.
(3). The work machine of (1) or (2), further comprising a heat sink in thermal communication with the hydraulic fluid impelled by the hydraulic pump.
(4). The work machine of (1), (2) or (3), wherein the heat sink is a metal surface on which the hollow channels are formed.
(5). The work machine of (1), (2), (3) or (4), wherein the metal surface is a bed of a hauling machine and the hollow channels are mechanical stiffeners.
(6). The work machine of (1), wherein the chassis includes hollow beams that transfers weight of the work machine, the interior of the hollow beams being in fluid communication with the hydraulic pump.
(7). A hauling machine comprising: a support structure having hollow structural components; a pump in fluid communication with the hollow structural components and constructed to impel hydraulic fluid stored therein; and a bed mechanically coupled to the support structure and operated into loading and dumping states by the impelled hydraulic fluid.
(8). The hauling machine of (7), wherein the support structure is distributed as hollow channels constructed to contain the impelled hydraulic fluid.
(9). The hauling machine of (7) or (8), further comprising a heat sink in thermal communication with the hydraulic fluid impelled in the support structure.
(10). The hauling machine of (7), (8) or (9), wherein the heat sink is a metal surface on which the hollow channels are formed.
(11). The hauling machine of (7), (8), (9) or (10), wherein the metal surface is the bed of a hauling machine, and the hollow channels are mechanical stiffeners.
(12). The hauling machine of (7), further comprising a chassis comprising hollow beams that carries the weight of the work machine, the interior of the hollow beams being in fluid communication with the hydraulic pump.
(13). The hauling machine of (7), wherein the structural components include an interior bladder in fluid communication with the hydraulic pump.
(14). A work machine comprising: a hydraulic pump in fluid communication with an interior of a support structure and constructed to impel hydraulic fluid stored therein; and work machinery mechanically coupled to the support structure and operated by the impelled hydraulic fluid.
(15). The work machine of (14), wherein the support structure is distributed as hollow channels constructed to contain the impelled hydraulic fluid.
(16). The work machine of (14) or (15), further comprising a heat sink in thermal communication with the hydraulic fluid impelled in the support structure.
(17). The work machine of (14), (15) or (16), wherein the heat sink is a metal surface on which the hollow channels are formed.
(18). The work machine of (14), (15), (16) or (17), wherein the metal surface is a bed of a hauling machine and the hollow channels are mechanical stiffeners.
(19). The work machine of (14), wherein the support structure includes a chassis comprising hollow beams that transfers weight of the work machine, the interior of the hollow beams being in fluid communication with the hydraulic pump.
(20). The work machine of (14), wherein the interior of the support structure contains a bladder constructed to contain the hydraulic fluid.

### INDUSTRIAL APPLICABILITY

Heavy work machines, e.g., hauling machines, excavators, dozers, etc. have work implements, e.g., hauling beds, excavator boom/stick, dozer blades, etc. perform work tasks using hydraulic power delivered by a hydraulic pump. The work tasks may increase the temperature of the hydraulic fluid and thermal management techniques may be applied to dissipate that heat.

The hydraulic pump may retrieve hydraulic fluid from a dedicated fluid reservoir tank and provide it to the work implements. Such a reservoir tank can be omitted by embodiments of the present inventive concept as the reservoir comprises hollow support structure components, e.g., stiffeners, chassis beams, etc., that may be distributed over the work machine. Accordingly, the elimination of the fluid reservoir may be effected thus saving work machine costs.

The distributed fluid reservoir of the present inventive concept may offer improved heat dissipation over previous hydraulic systems. That is, in storing the hydraulic fluid in a distributed fashion allows using the structural components, work implements, etc., as heat sinks.

The foregoing features have broad applicability in industry. The present inventive concept may be applied to techniques other than those applied to work machines.

The descriptions above are intended to illustrate possible implementations of the present inventive concept and are not restrictive. Many variations, modifications and alternatives will become apparent to the skilled artisan upon review of this disclosure. For example, components equivalent to those shown and described may be substituted therefore, elements and methods individually described may be combined, and elements described as discrete may be distributed across many components. The scope of the invention should therefore be determined not with reference to the description above, but with reference to the appended claims, along with their full range of equivalents.

What is claimed is:

1. A work machine comprising:
a chassis;
a support structure having a hollow interior and mechanically coupled to the chassis;
a bladder within the hollow interior of the support structure and constructed to contain hydraulic fluid therein;
a hydraulic pump in fluid communication with the interior of the bladder and constructed to impel the hydraulic fluid stored therein; and
hydraulic work machinery mechanically coupled to the chassis and operated by the impelled hydraulic fluid.

2. The work machine of claim 1, wherein the support structure is distributed over the work machine as hollow channels constructed to contain respective bladders.

3. The work machine of claim 2, further comprising a heat sink in thermal communication with the hydraulic fluid impelled by the hydraulic pump.

4. The work machine of claim 3, wherein the heat sink is a metal surface on which the hollow channels are formed.

5. The work machine of claim 4, wherein the metal surface is a bed of a hauling machine and the hollow channels are mechanical stiffeners.

6. The work machine of claim 1, wherein the chassis includes hollow beams that transfers weight of the work machine, the interior of the hollow beams being in fluid communication with the hydraulic pump.

7. A hauling machine comprising:
a support structure having hollow structural components;
a pump in fluid communication with the hollow structural components and constructed to impel hydraulic fluid stored therein; and
a bed mechanically coupled to the support structure and operated into loading and dumping states by the impelled hydraulic fluid.

8. The hauling machine of claim 7, wherein the support structure is distributed as hollow channels constructed to contain the impelled hydraulic fluid.

9. The hauling machine of claim 8, further comprising a heat sink in thermal communication with the hydraulic fluid impelled in the support structure.

10. The hauling machine of claim 9, wherein the heat sink is a metal surface on which the hollow channels are formed.

11. The hauling machine of claim 10, wherein the metal surface is the bed of a hauling machine, and the hollow channels are mechanical stiffeners.

12. The hauling machine of claim 7, further comprising a chassis comprising hollow beams that carries the weight of the work machine, the interior of the hollow beams being in fluid communication with the hydraulic pump.

13. The hauling machine of claim 7, wherein the structural components include an interior bladder in fluid communication with the hydraulic pump.

14. A work machine comprising:
a hydraulic pump in fluid communication with an interior of a support structure and constructed to impel hydraulic fluid stored therein; and
work machinery mechanically coupled to the support structure and operated by the impelled hydraulic fluid.

15. The work machine of claim 14, wherein the support structure is distributed as hollow channels constructed to contain the impelled hydraulic fluid.

16. The work machine of claim 15, further comprising a heat sink in thermal communication with the hydraulic fluid impelled in the support structure.

17. The work machine of claim 16, wherein the heat sink is a metal surface on which the hollow channels are formed.

18. The work machine of claim 17, wherein the metal surface is a bed of a hauling machine and the hollow channels are mechanical stiffeners.

19. The work machine of claim 14, wherein the support structure includes a chassis comprising hollow beams that transfers weight of the work machine, the interior of the hollow beams being in fluid communication with the hydraulic pump.

20. The work machine of claim 14, wherein the interior of the support structure contains a bladder constructed to contain the hydraulic fluid.
